(19) United States
(12) Patent Application Publication
(10) Pub. No.: US 2011/0192055 A1
(43) Pub. Date: Aug. 11, 2011

(54) REINFORCEMENT DEVICE FOR BOOTS

(76) Inventor: Kim L. Olenicoff, Irvine, CA (US)

(21) Appl. No.: 13/020,422

(22) Filed: Feb. 3, 2011

Related U.S. Application Data
(60) Provisional application No. 61/301,924, filed on Feb. 5, 2010.

(51) Int. Cl. A43B 23/02; B32B 37/02; B32B 37/10; B32B 37/12; B32B 37/14; B32B 38/10; B32B 3/00

(52) U.S. Cl. 36/109; 156/249; 428/189

(57) ABSTRACT

Embodiments of the invention are directed to reinforcement devices and methods to prevent or substantially prevent a thigh high boot from slouching. In one embodiment, the reinforcement device is comprised of an elongate stiffener sandwiched between an elongate sheet material and an adhesive film. According to one method, the reinforcement device may be placed on the inside surface of a thigh high boot so that that the boot stays rigid during wear.

### CLAIM OF PRIORITY UNDER 35 U.S.C. §119

This application claims the benefit of U.S. Provisional Application No. 61/301,924 entitled “Reinforcement Device for Boots” filed Feb. 5, 2010.

### FIELD OF INVENTION

At least one feature pertains to reinforcement devices for boots.

### BACKGROUND OF INVENTION

The global fashion industry is an extremely profitable enterprise. Members of the fashion industry are constantly inventing and re-inventing lines of clothing as trends enter, phase out of, and re-enter the industry at various times. Shoes are an integral part of the fashion industry and many shoe lines are extremely profitable as well. During winter or colder seasons, boot lines are often highlighted and heavily marketed in the fashion industry.

Fashion boots come in all different styles including ankle boots, slouch boots, mid-calf boots, booties, wedge boots, demi boots, knee high boots, thigh high boots and platform boots to name a few. One popular fashion boot which often makes an appearance is the thigh high boot. Because of the nature of the thigh high, i.e., that it terminates up and over the knee, the material used to construct this type of boot must be sufficiently pliable. Generally, one of leather, suede, stretch patent leather, crepe elastic and other like materials is typically used in the construction of this type of boot.

Thigh high boots tend to slouch due to its construction material (i.e., pliable material) and repeated wearing of the boot over time. Even thigh highs which are constructed from more sturdy materials, like leather, typically eventually begin to slouch. In addition to being un-aesthetically pleasing, this problem often forces the wearer to have to repeatedly pull up the thigh high when worn. Boot wearers can wear two pairs of socks to prevent slouching, however, the wearer could get very hot. Additionally, once the material stretches over the additional sock, the next time the wearer would have to wear three pairs, then four pairs, etc. Boot wearers can also tape the boots around the top (i.e., the part of the boot about the thigh just above the knee) to the pants or leg; however, excessive walking or movement causes the tape to pull away. Moreover, this quick-fix can be uncomfortable. The wearer will often stop wearing their thigh highs as the tendency to slouch increases over time.

Consequently, a device and methods for alleviating the problems discussed above is needed.

### SUMMARY OF INVENTION

A reinforcement device to stiffen a portion of a boot, comprising: (a) an elongate sheet material comprising a front surface; (b) an adhesive film comprising a back surface; and (c) an elongate stiffener positioned between the elongate sheet material and the adhesive film wherein the elongate sheet material and the adhesive film have the same width and the elongate stiffener has a width smaller than the elongate sheet material or the adhesive film is herein disclosed. The adhesive film may have adhesive on both surfaces. The elongate stiffener may have properties of stiffness and flexibility.

A combination, comprising: (a) a boot having a reinforcement device affixed thereto, the reinforcement device consisting of: (i) an elongate sheet material comprising a front surface; (ii) an adhesive film comprising a back surface; and (iii) an elongate stiffener positioned between the elongate sheet material and the adhesive film wherein the elongate sheet material and the adhesive film have the same width and the elongate stiffener has a width smaller than the elongate sheet material or the adhesive film is herein disclosed. The adhesive film may have adhesive on both surfaces. The elongate stiffener may have properties of stiffness and flexibility.

A method of stiffening a portion of a boot, comprising: (a) removing protective backing from a reinforcement device, the reinforcement device comprising: (i) an elongate sheet material comprising a front surface; (ii) an adhesive film comprising a back surface; and (iii) an elongate stiffener positioned between the elongate sheet material and the adhesive film wherein the elongate sheet material and the adhesive film have the same width and the elongate stiffener has a width smaller than the elongate sheet material or the adhesive film; (b) positioning the back surface of the reinforcement device against an inner surface of a boot; (c) applying pressure to the reinforcement device is herein disclosed.

### BRIEF DESCRIPTION OF DRAWINGS

FIG. 1 illustrates a front view of a reinforcement device according to an embodiment of the invention.

FIG. 2 illustrates a side view of the reinforcement device of FIG. 1.

### DETAILED DESCRIPTION

The following detailed description is of the best currently contemplated modes of carrying out the invention. The description is not to be taken in a limiting sense, but is made merely for the purpose of illustrating the general principles of the invention.

Embodiments of the invention are directed to reinforcement devices and methods to prevent or substantially prevent a thigh high boot from slouching. In one embodiment, the reinforcement device is comprised of an elongate stiffener sandwiched between an elongate sheet material and an adhesive film. According to one method, the reinforcement device may be placed on the inside surface of a thigh high boot so that that the boot stays rigid during wear.

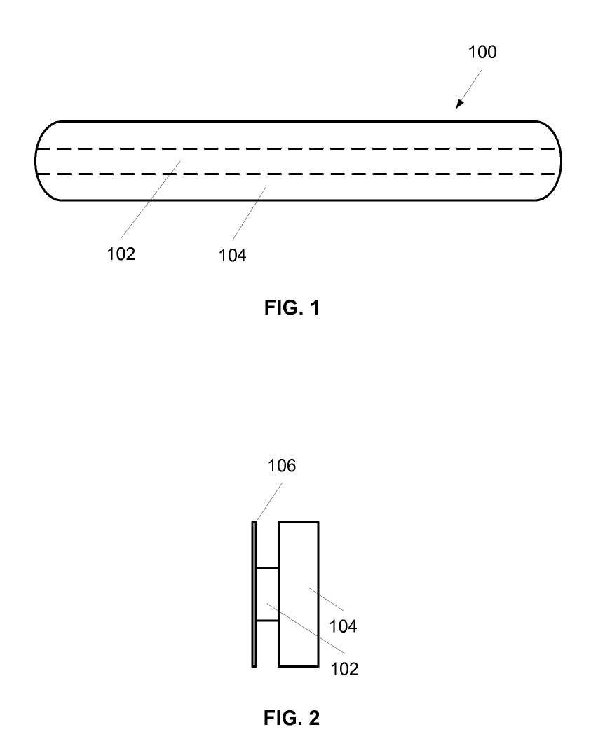

FIG. 1 illustrates a front view of a reinforcement device according to an embodiment of the invention. Reinforcement device 100 may be generally elongate from a proximal end to a distal end thereof. As shown, reinforcement device 100 may have rounded proximal and distal ends. Reinforcement device 100 may include one or more layers. In one embodiment, reinforcement device 100 may include an elongate stiffener 102 sandwiched between an elongate sheet material 104 (“front surface”) and an adhesive film 106 (“back surface”, not shown, see FIG. 2). In an alternative embodiment, reinforcement device 100 may have the following arrangement: elongate sheet material 104 followed by adhesive film 106 followed by elongate stiffener 102. Elongate stiffener 102 may be made of a synthetic material such as vinyl polymer or a paper-based material such as card stock. In any embodiment, elongate stiffener 102 should be sufficiently rigid yet flexible. Additionally, elongate stiffener 102 should conform or substantially conform to its original shape after repeated flexing. In one embodiment, elongate stiffener 102 is between about 0.25 inches and about one (1) inch in width, preferably about 0.5 inches in width. Additionally, elongate stiffener 102 may be between about five (5) inches in length and about ten (10) inches in length, preferably about seven (7) inches in length.

Elongate sheet material 104 may be made of a natural or synthetic material such as cotton, polyester or any other suitable material. In any embodiment, the material should be made from a material which preferably will not irritate the skin of an average person. In one embodiment, elongate sheet material 104 is between about two (2) inches and about one (1) inch in width, preferably about 1.25 inches in width. Additionally, elongate sheet material 104 may be between about five (5) inches in length and about ten (10) inches in length, preferably about seven (7) inches in length.

FIG. 2 illustrates a side view of the reinforcement device of FIG. 1. As shown, reinforcement device 200 includes elongate stiffener 202 sandwiched between elongate sheet material 204 and adhesive film 206. In some embodiments, adhesive film 202 may be double-sided tape comprised of adipic acid dihydride (ADH) or acrylic with a polyester (PET) carrier or equivalent. Reinforcement device 200 may include a protective backing 208 to maintain the integrity of adhesive film 206 before use.

According to embodiments of the invention, one or more reinforcement devices as previously described may be attachable to the inside of a boot in order to prevent or substantially prevent the boot from slouching while being worn by a user. The reinforcement device is rigid enough to prevent the boot from falling down yet flexible and gentle enough so as to substantially or completely prevent chaffing to the user. In one method, the protective backing may be peeled away from the back surface of the reinforcement device. The reinforcement device may then be positioned within any inner surface of the boot, preferably in a longitudinal direction. Light pressure may be applied to the reinforcement device to keep it in position. To position the reinforcement device around the top portion of the boot (i.e., the area about the thigh for a thigh high boot) the user may choose to cut the reinforcement device in one or more pieces.

While certain exemplary embodiments have been described and shown in the accompanying drawings, it is to be understood that such embodiments are merely illustrative of and not restrictive on the broad invention, and that this invention is not to be limited to the specific constructions and arrangements shown and described, since various other modifications may occur to those ordinarily skilled in the art.

What is claimed is:

1. A reinforcement device to stiffen a portion of a boot, comprising:
an elongate sheet material comprising a front surface;
an adhesive film comprising a back surface; and
an elongate stiffener positioned between the elongate sheet material and the adhesive film wherein the elongate sheet material and the adhesive film have the same width and the elongate stiffener has a width smaller than the elongate sheet material or the adhesive film.

2. The reinforcement device of claim 1 wherein the adhesive film is adhesive on both surfaces.

3. The reinforcement device of claim 2 wherein the elongate stiffener has properties of stiffness and flexibility.

4. A combination, comprising:
a boot having a reinforcement device affixed thereto, the reinforcement device consisting of:
an elongate sheet material comprising a front surface;
an adhesive film comprising a back surface; and
an elongate stiffener positioned between the elongate sheet material and the adhesive film wherein the elongate sheet material and the adhesive film have the same width and the elongate stiffener has a width smaller than the elongate sheet material or the adhesive film.

5. The combination of claim 4 wherein the adhesive film is adhesive on both surfaces.

6. The combination of claim 4 wherein the elongate stiffener has properties of stiffness and flexibility.

7. A method of stiffening a portion of a boot, comprising:
removing protective backing from a reinforcement device, the reinforcement device comprising:
an elongate sheet material comprising a front surface;
an adhesive film comprising a back surface; and
an elongate stiffener positioned between the elongate sheet material and the adhesive film wherein the elongate sheet material and the adhesive film have the same width and the elongate stiffener has a width smaller than the elongate sheet material or the adhesive film;
positioning the back surface of the reinforcement device against an inner surface of a boot;
applying pressure to the reinforcement device.
